(19) United States
(12) Patent Application Publication
(10) Pub. No.: US 2026/0058191 A1
(43) Pub. Date: Feb. 26, 2026

(54) CLAD FOIL-FREE BIPOLAR SOLID-STATE BATTERY CELL

(71) Applicant: GM Global Technology Operations LLC, Detroit, MI (US)

(72) Inventors: Qili Su, Shanghai (CN); Zhe Li, Shanghai (CN); Xingcheng Xiao, Troy, MI (US); Haijing Liu, Shanghai (CN)

(21) Appl. No.: 18/914,927

(22) Filed: Oct. 14, 2024

(30) Foreign Application Priority Data
Aug. 20, 2024 (CN) 202411143781X

(51) Int. Cl. H01M 10/0562; H01M 4/02; H01M 4/131; H01M 4/525; H01M 4/62; H01M 4/66; H01M 4/75

(52) U.S. Cl. CPC H01M 10/0562; H01M 4/131; H01M 4/525; H01M 4/623; H01M 4/661; H01M 4/667; H01M 4/75; H01M 2004/021; H01M 2004/028; H01M 2004/029; H01M 2300/0068

(57) ABSTRACT

A bipolar battery cell including A anode/bipolar current collectors comprising an aluminum foil layer. A first side of the aluminum foil layer includes lithium-aluminum alloy sublayer and a second side of the aluminum foil layer includes unreacted aluminum sublayer. S separators include a first side arranged adjacent to the first side of a corresponding one of the A anode/bipolar current collectors. C cathode active material layers include a first side arranged adjacent to the second side of a corresponding one of the A anode/bipolar current collectors and a second side arranged adjacent to the second side of a corresponding one of the S separators. A, C, and S are integers greater than one.

### CROSS-REFERENCE TO RELATED APPLICATIONS

This application claims the benefit of Chinese Patent Application No. 202411143731.X, filed on Aug. 20, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a clad foil-free bipolar solid-state battery cell.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Bipolar battery cells include cathode electrodes, anode electrodes, and separators. The cathode electrodes include a cathode active material layer (including cathode active material) arranged on one side of a clad bipolar current collector such as clad foil. The anode electrodes include an anode active material layer (including anode active material) arranged on the other side of the clad bipolar current collector.

### SUMMARY

A bipolar battery cell including A anode/bipolar current collectors comprising an aluminum foil layer. A first side of the aluminum foil layer includes lithium-aluminum alloy sublayer and a second side of the aluminum foil layer includes unreacted aluminum sublayer. S separators include a first side arranged adjacent to the first side of a corresponding one of the A anode/bipolar current collectors. C cathode active material layers include a first side arranged adjacent to the second side of a corresponding one of the A anode/bipolar current collectors and a second side arranged adjacent to the second side of a corresponding one of the S separators. A, C, and S are integers greater than one.

In some examples, the aluminum foil layer has a grain boundary distribution greater than 15%. The aluminum foil layer has a grain boundary distribution in a range from 20 to 45%. The aluminum foil layer comprises aluminum in a range from 80 wt % to 99.9 wt %. The aluminum foil layer has a thickness in a range from 6 to 60 μm. The second side of the aluminum foil layer is coated with a carbon layer. The first side of the aluminum foil layer is anodized.

In other features, the S separators comprise solid electrolyte including sulfide and poly(ethylene oxide) (PEO) binder. The C cathode active material layers include cathode active material and polytetrafluoroethylene (PTFE) binder.

A bipolar battery cell includes a first cathode electrode comprising a cathode active material layer arranged on a cathode current collector. A first separator is arranged adjacent to the first cathode electrode. N units, arranged adjacent to the first separator, comprise a first anode/bipolar current collector comprising an aluminum foil layer, wherein a first side of the aluminum foil layer includes lithium-aluminum alloy and a second side includes unreacted aluminum, a cathode active material layer arranged adjacent to the first anode/bipolar current collector, and a second separator including a first side arranged adjacent to the cathode active material layer. A second anode/bipolar current collector is arranged adjacent to a last one of the N units. N is an integer greater than zero.

In other features, the aluminum foil layer has a grain boundary distribution in a range from 15 to 45%. The aluminum foil layer comprises aluminum in a range from 80 wt % to 99.9 wt %. The aluminum foil layer has a thickness in a range from 6 to 60 μm. The second side of the aluminum foil layer is coated with a carbon layer. The first side of the aluminum foil layer is anodized.

In other features, the first separator includes solid electrolyte including sulfide and poly(ethylene oxide) (PEO) binder, and the cathode active material layer includes cathode active material and polytetrafluoroethylene (PTFE) binder.

A bipolar battery cell includes a first cathode electrode comprising a cathode active material layer arranged on a cathode current collector. N units, arranged adjacent to the first cathode electrode, comprise a first separator arranged adjacent to the first cathode electrode, a first anode/bipolar current collector comprising an aluminum foil layer, wherein a first side of the aluminum foil layer is arranged adjacent to the first separator and includes lithium-aluminum alloy and a second side includes unreacted aluminum, and a cathode active material layer arranged adjacent to the second side of the first anode/bipolar current collector. A second separator includes a first side arranged adjacent to the cathode active material layer. A second anode/bipolar current collector is arranged adjacent to the second separator. N is an integer greater than zero.

In other features, the aluminum foil layer has a grain boundary distribution in a range from 15% to 45%, the aluminum foil layer comprises aluminum in a range from 80 wt % to 99.9 wt %, and the aluminum foil layer has a thickness in a range from 6 to 60 μm.

In other features, the second side of the aluminum foil layer is coated with a carbon layer. The first side of the aluminum foil layer is anodized. The S separators comprise solid electrolyte including sulfide and poly(ethylene oxide) (PEO) binder, and the C cathode active material layers include cathode active material and polytetrafluoroethylene (PTFE) binder.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a bipolar battery cell including a clad bipolar current collector;

FIGS. 2A and 2B are side cross sections of examples of cathode and anode electrodes;

FIG. 3A is a side cross section of an example of a bipolar battery cell including a combined anode/bipolar current collector according to the present disclosure;

FIG. 3B is a side cross section of an example of a combined anode/bipolar current collector according to the present disclosure;

FIG. 3C is a side cross section of an example of a combined anode/bipolar current collector according to the present disclosure;

FIGS. 4 and 5 are side cross sections of examples of bipolar battery cells including repeating units according to the present disclosure;

FIGS. 6A and 6B are side cross sections of examples of a combined anode/bipolar current collector including a carbon layer according to the present disclosure;

FIG. 7 is a side cross section of examples of a combined anode/bipolar current collector including an anodized surface according to the present disclosure;

FIG. 8 is a side cross section of an example of a bipolar battery cell including repeating units according to the present disclosure;

FIGS. 9 and 10 are graphs illustrating performance of the bipolar battery cells according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

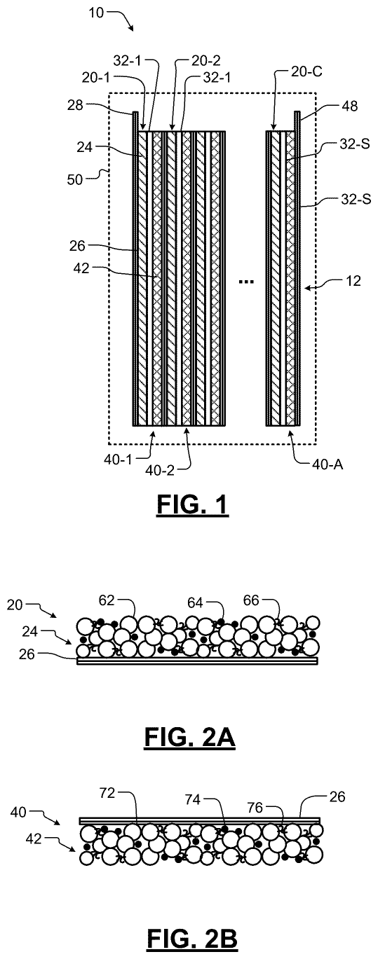

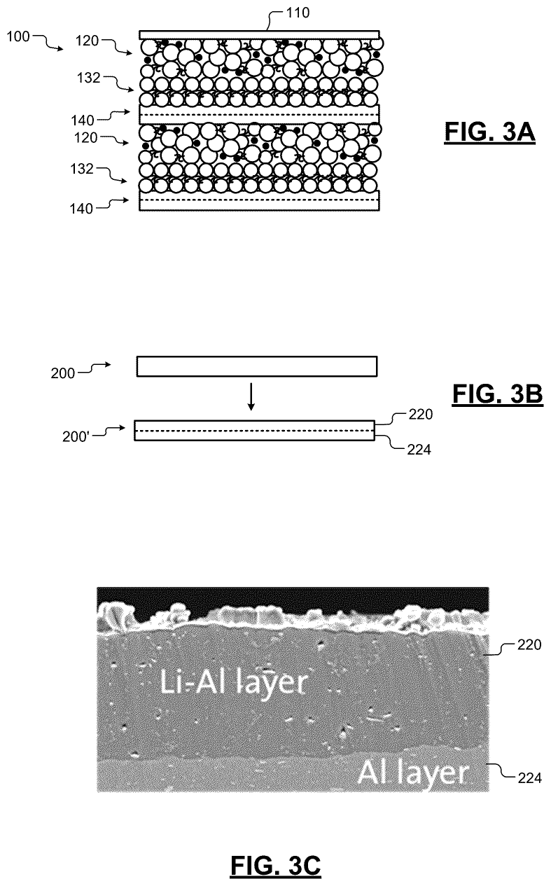

Bipolar battery cells include cathode electrodes and anode electrodes with sides separated by separators. Clad current collectors separate the other sides of the cathode electrodes and anode electrodes. FIGS. 1 to 2B show an example bipolar battery cell including clad current collectors. FIGS. 3A to 10 include a combined anode and current collector that replaces the clad current collectors according to the present disclosure. The bipolar battery cell is cost effective due to the low-cost anode and low-cost bipolar current collector. The battery cell structure is simplified and fabrication friendly.

Referring now to FIG. 1, a bipolar battery cell 10 such as a solid-state battery cell is shown. The bipolar battery cell 10 includes C cathode electrodes 20-1, . . . , and 20-C, A anode electrodes 40-1, . . . , and 40-A, and S separators 32-1, . . . , and 32-S. The cathode electrodes and anode electrodes are arranged in an alternating bipolar sequence in a battery cell stack 12, where C, S and A are integers greater than zero. The battery cell stack 12 is arranged in an enclosure 50.

The C cathode electrodes 20-1, 20-2, . . . , and 20-C include a cathode active material layer 24 arranged on first sides of bipolar current collectors 26. The A anode electrodes 40-1, 40-2, . . . , and 40-A include anode active material layers 42 arranged on second sides of the bipolar current collectors 26. The S separators 32-1, 32-2, . . . , and 32-S are arranged between other sides of the C cathode electrodes 20 and the A anode electrodes 40.

In some examples, the A anode electrodes 40 and the C cathode electrodes 20 exchange lithium ions during charging/discharging. In some examples, the cathode active material layers 24 comprise coatings including one or more active materials, one or more conductive additives, and/or one or more binder materials.

In some bipolar battery cells, the bipolar current collectors 26 include first and second metal foil layers such as copper and aluminum that are mechanically bonded to form a clad bipolar current collector. External tabs 28 and 48 are connected to electrodes on opposite ends of the bipolar battery cell 10. The external tabs 28 and 48 are connected to terminals of the battery cells.

Referring now to FIGS. 2A and 2B, examples of the cathode and anode electrodes are shown. In FIG. 2A, one of the C cathode electrodes 20 is shown in more detail. The cathode active material layer 24 includes a cathode active material 62, a conductive additive 64, and a binder 66 arranged on one side (e.g., the aluminum foil side) of the clad bipolar current collector 26.

In FIG. 2B, one of the A anode electrodes 40 is shown in more detail. The anode active material layer 42 includes an anode active material 72, an optional conductive additive 74, and an optional binder 76 arranged on the other side (e.g., the copper foil side) of the clad bipolar current collector 26.

The clad bipolar current collector 26 is typically manufactured using a physical roll bonding process. Bonding of the foil layers (e.g., aluminum and copper) occurs only when the surfaces are clean and compressed with a sufficiently high pressure between a pair of rollers to deform the metal foil layers. It is difficult to manufacture the clad bipolar current collector 26 with a thin thickness. Typically, the clad bipolar current collector 26 has a thickness in a range from 35 μm to 500 μm. During cladding, annealing may be performed to mechanically bond the clad layers, which increases manufacturing time and cost. The clad bipolar current collector 26 is also prone to delamination, particularly during bending of the clad foil.

A bipolar current collector according to the present disclosure includes an aluminum foil layer that is configured to function as both an anode active material to accept lithium ions and a bipolar current collector to conduct electrons between adjacent cell units. In some examples, the aluminum foil layer has a grain boundary distribution greater than 15%. In some examples, the aluminum foil layer has a grain boundary distribution in a range from 20 to 45% (e.g., 35%).

During bipolar battery charging, the aluminum foil layer is lithiated in a direction perpendicular to the electrode/electrolyte interface to form a dense Li—Al alloy layer. The thickness of the Li—Al layer can be controlled based on cathode loading. The unreacted aluminum foil acts as the current lead to transport electrons between the bipolar cell units.

Referring now to FIG. 3A, a bipolar battery cell 100 according to the present disclosure is shown. The bipolar battery cell 100 includes cathode active material layers 120 (one arranged on a cathode current collector 110), separators 132, and anode/bipolar current collectors 140. In this example, some of the cathode active material layers 120 are arranged between one side of the anode/bipolar current collectors 140 and one side of the separators 132. The other side of the separators 132 is arranged adjacent to the other side of the anode of anode/bipolar current collectors 140.

Referring now to FIGS. 3B and 3C, an aluminum foil layer 200 and 200′ is shown before lithiation and after lithiation in situ during battery charging, respectively. In FIG. 3B, the aluminum foil layer 200 is lithiated in situ in a direction perpendicular to the electrode/electrolyte interface. A Li—Al alloy layer 220 is formed on one side of an aluminum foil layer 200′ and an unreacted aluminum foil layer 224 is located on the other side of the aluminum foil layer 200′ as can also be seen in FIG. 3C.

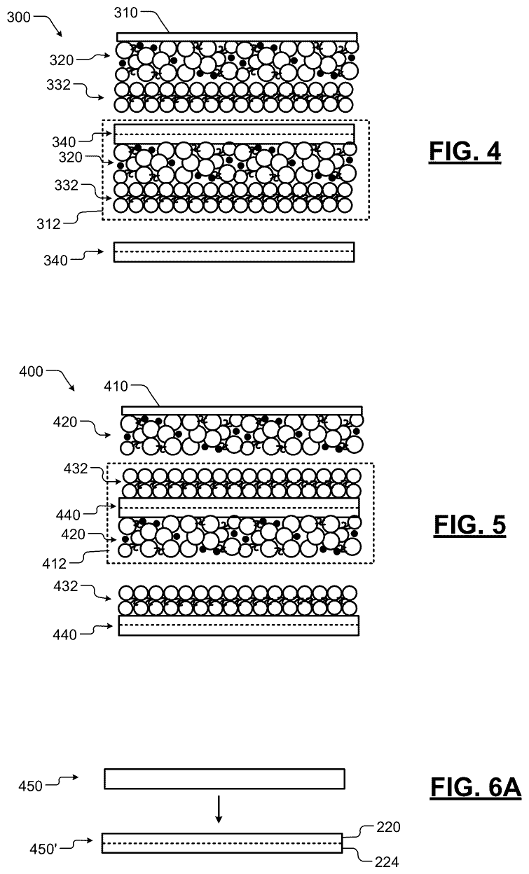

As can be appreciated, the bipolar battery cell can be manufactured with different numbers of electrodes and separators using a repeating unit. In FIG. 4, a bipolar battery cell 300 includes a cathode current collector 310, a cathode active material layer 320 and a separator 332. Each of N units 312 (where N is an integer greater than zero) includes an anode/bipolar current collector 340, a cathode active material layer 320, and a separator 332. Another anode/bipolar current collector 340 is arranged on the other side of the N units 312.

In FIG. 5, a bipolar battery cell 400 includes a cathode current collector 410 and a cathode active material layer 420. Each of N units 412 (where N is an integer greater than zero) includes a separator 432, an anode/bipolar current collector 440, and a cathode active material layer 420. A separator 432 and an anode/bipolar current collector 440 are arranged on the other side of the N units 412.

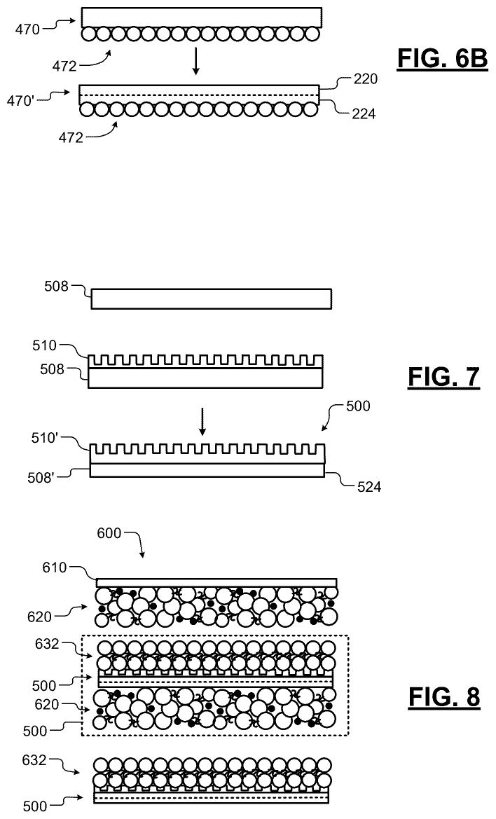

Referring now to FIG. 6A, another method for manufacturing an anode/bipolar current collector is shown. An aluminum foil layer 450 and 450′ is shown before lithiation pre-treatment and after lithiation pretreatment, respectively. The aluminum foil layer 450 is lithiated on one side. For example, the aluminum foil can be pretreated using lithium foil. The lithium foil and the aluminum foil react to form Li—Al alloy. A first sublayer of the aluminum foil facing the lithium foil is converted to Li—Al alloy. A second sublayer of the aluminum foil does not contact the lithium foil and does not react. After lithiation pretreatment, the aluminum foil layer 450′ acts as the anode/bipolar current collector. The aluminum foil layer 450′ includes a Li—Al alloy layer 220 on one side and an unreacted aluminum foil layer 224 on the other side.

In some examples, the aluminum foil layer includes 80 to 99.9 wt % Al. In some examples, the aluminum foil layer includes 95 to 99.9 wt % Al (e.g., 98.6 wt %). In some examples, the thickness of the aluminum foil is in a range from 6 to 60 μm. In some examples, the thickness of the aluminum foil is in a range from 30 to 50 μm (e.g., 40 μm). In some examples, the aluminum foil layer has a grain boundary distribution greater than 15%. In some examples, the aluminum foil layer has a grain boundary distribution in a range from 20 to 45% (e.g., 35%).

Examples of aluminum foil layers with high grain boundary distribution can be found in commonly assigned U.S. patent application Ser. No. 18/760,281 and Ser. No. 18/760,389 (corresponding to GM Docket Nos. P107816 and P107895), which are hereby incorporated herein by reference in their entirety. In some examples, the aluminum foil layer is rolled and annealed to increase the grain boundary distribution. In some examples, the aluminum foil layer further includes iron (Fe) to increase the grain boundary distribution.

Referring now to FIG. 6B, another method for manufacturing an anode/current collector is shown. An aluminum foil layer 470 and 470′ is shown before lithiation pre-treatment and after lithiation pre-treatment, respectively. The aluminum foil layer 470 is coated with a conductive carbon layer 472 and then pretreated. The conductive carbon layer 472 inhibits potential short circuits and acts as the electron conduction network for the cathode electrodes and anode electrodes. The aluminum foil layer 470′ is lithiated on one side and includes a Li—Al alloy layer 220 on one side and an unreacted aluminum foil layer 224 on the other side.

Referring now to FIG. 7, another method for manufacturing an anode/bipolar current collector 500 is shown. An aluminum foil layer 508 and 508′ is shown before lithiation pre-treatment and after lithiation pre-treatment, respectively. The aluminum foil layer 508 is anodized to create an anodized layer 510 (e.g., aluminum oxide) on one side and then pretreated. The anodized layer 510′ and part of the aluminum foil layer 508′ are lithiated to form lithium aluminum oxide alloy (Li—AlO₂) and lithium alloy (Li—Al), respectively. The anodized layer 510′ increases interfacial contact. An unreacted aluminum foil layer 524 is located on the other side.

In FIG. 8, a bipolar battery cell 600 includes a cathode current collector 610 and a cathode active material layer 620. Each of N units 612 (where Nis an integer greater than zero) includes a separator 632, an anode/bipolar current collector 500, and a cathode active material layer 620. A separator 632 and an anode/bipolar current collector 500 are arranged on the other side of the N units 612.

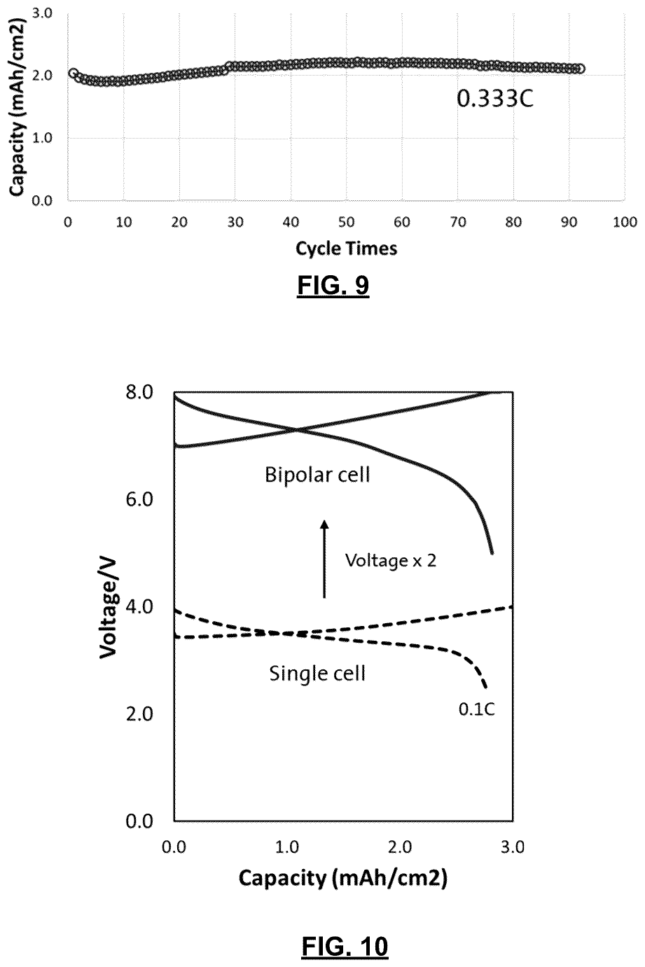

Referring now to FIGS. 9 and 10, performance of the bipolar solid-state battery cell is shown. In FIG. 9, capacity is shown as a function of cycle number. In FIG. 10, voltage is shown as a function of capacity. In this example, the cathode electrodes include 3 mAh/cm² NMC721. The anodes include 40 μm Al/Fe foil lithiated with 10 wt % Li. The separator includes sulfide electrolyte. The cathode active material layer includes polytetrafluoroethylene (PTFE) as the binder and the separator includes poly(ethylene oxide) (PEO) as the binder. As can be seen, the bipolar solid-state battery cell delivers most of the cathode capacity and works well at 0.333 C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A bipolar battery cell comprising:
A anode/bipolar current collectors comprising an aluminum foil layer,
wherein a first side of the aluminum foil layer includes lithium-aluminum alloy sublayer and a second side of the aluminum foil layer includes unreacted aluminum sublayer;
S separators including a first side arranged adjacent to the first side of a corresponding one of the A anode/bipolar current collectors; and
C cathode active material layers including a first side arranged adjacent to the second side of a corresponding one of the A anode/bipolar current collectors and a second side arranged adjacent to the second side of a corresponding one of the S separators,
wherein A, C, and S are integers greater than one.

2. The bipolar battery cell of claim 1, wherein the aluminum foil layer has a grain boundary distribution greater than 15%.

3. The bipolar battery cell of claim 2, wherein the aluminum foil layer has a grain boundary distribution in a range from 20 to 45%.

4. The bipolar battery cell of claim 1, wherein the aluminum foil layer comprises aluminum in a range from 80 wt % to 99.9 wt %.

5. The bipolar battery cell of claim 1, wherein the aluminum foil layer has a thickness in a range from 6 to 60 μm.

6. The bipolar battery cell of claim 1, wherein the second side of the aluminum foil layer is coated with a carbon layer.

7. The bipolar battery cell of claim 1, wherein the first side of the aluminum foil layer is anodized.

8. The bipolar battery cell of claim 1, wherein:
the S separators comprise solid electrolyte including sulfide and poly(ethylene oxide) (PEO) binder, and
the C cathode active material layers include cathode active material and polytetrafluoroethylene (PTFE) binder.

9. A bipolar battery cell comprising:
a first cathode electrode comprising a cathode active material layer arranged on a cathode current collector;
a first separator arranged adjacent to the first cathode electrode;
N units, arranged adjacent to the first separator, comprising:
a first anode/bipolar current collector comprising an aluminum foil layer, wherein a first side of the aluminum foil layer includes lithium-aluminum alloy and a second side includes unreacted aluminum;
a cathode active material layer arranged adjacent to the first anode/bipolar current collector; and
a second separator including a first side arranged adjacent to the cathode active material layer; and
a second anode/bipolar current collector arranged adjacent to a last one of the N units,
wherein N is an integer greater than zero.

10. The bipolar battery cell of claim 9, wherein the aluminum foil layer has a grain boundary distribution in a range from 15 to 45%.

11. The bipolar battery cell of claim 9, wherein the aluminum foil layer comprises aluminum in a range from 80 wt % to 99.9 wt %.

12. The bipolar battery cell of claim 9, wherein the aluminum foil layer has a thickness in a range from 6 to 60 μm.

13. The bipolar battery cell of claim 9, wherein the second side of the aluminum foil layer is coated with a carbon layer.

14. The bipolar battery cell of claim 9, wherein the first side of the aluminum foil layer is anodized.

15. The bipolar battery cell of claim 9, wherein:
the first separator includes solid electrolyte including sulfide and poly(ethylene oxide) (PEO) binder, and
the cathode active material layer includes cathode active material and polytetrafluoroethylene (PTFE) binder.

16. A bipolar battery cell comprising:
a first cathode electrode comprising a cathode active material layer arranged on a cathode current collector;
N units, arranged adjacent to the first cathode electrode, comprising:
a first separator arranged adjacent to the first cathode electrode;
a first anode/bipolar current collector comprising an aluminum foil layer, wherein a first side of the aluminum foil layer is arranged adjacent to the first separator and includes lithium-aluminum alloy and a second side includes unreacted aluminum; and
a cathode active material layer arranged adjacent to the second side of the first anode/bipolar current collector;
a second separator including a first side arranged adjacent to the cathode active material layer of a last one of the N units; and
a second anode/bipolar current collector arranged adjacent to the second separator,
wherein N is an integer greater than zero.

17. The bipolar battery cell of claim 16, wherein:
the aluminum foil layer has a grain boundary distribution in a range from 15% to 45%,
the aluminum foil layer comprises aluminum in a range from 80 wt % to 99.9 wt %, and
the aluminum foil layer has a thickness in a range from 6 to 60 μm.

18. The bipolar battery cell of claim 16, wherein the second side of the aluminum foil layer is coated with a carbon layer.

19. The bipolar battery cell of claim 16, wherein the first side of the aluminum foil layer is anodized.

20. The bipolar battery cell of claim 16, wherein:
the S separators comprise solid electrolyte including sulfide and poly(ethylene oxide) (PEO) binder, and
the C cathode active material layers include cathode active material and polytetrafluoroethylene (PTFE) binder.
